(19) United States
(12) Patent Application Publication
(10) Pub. No.: US 2014/0231101 A1
(43) Pub. Date: Aug. 21, 2014

(54) GLUED-ON HORSE BOOT WITH FROG SUPPORT

(71) Applicant: GARRETT N. FORD, DURANGO, CO (US)

(72) Inventor: GARRETT N. FORD, DURANGO, CO (US)

(73) Assignee: EASYCARE, INC., TUCSON, AZ (US)

(21) Appl. No.: 14/184,675

(22) Filed: Feb. 19, 2014

Related U.S. Application Data
(63) Continuation-in-part of application No. 14/165,646, filed on Jan. 28, 2014.
(60) Provisional application No. 61/766,906, filed on Feb. 20, 2013.
(60) Provisional application No. 61/873,368, filed on Sep. 4, 2013.

(51) Int. Cl. A01L 3/02

(52) U.S. Cl. CPC A01L 3/02
USPC 168/12; 168/4

(57) ABSTRACT

A horse boot has an upper that includes substantially independent side walls that may be flexed inward or outward as needed to conform to the shape of the hoof to which the boot is fitted. The upper has no front portion and is preferably integral with a polymeric horseshoe with free heel ends defining a gap. A cantilevered resilient frog support connects the heel ends of the horseshoe, thus providing a spring-like structure tying the heel ends together. The interior surface of the horseshoe has a grid of interconnected recesses and the upper has lateral perforations adapted to receive glue material. The boot is fitted to the hoof by lining the surfaces of the upper and the horseshoe with glue and holding the boot in place while the glue hardens, thereby securing the boot to the hoof. The entire fitting process may be carried out in a few minutes and the boot remains in place essentially without maintenance.

### RELATED APPLICATIONS

This application is based on and claims the priority of Provisional Application Ser. No. 61/766,906, filed Feb. 20, 2013, and of U.S. Ser. No. 14/165,646, filed Jan. 28, 2014, which in turn is based on Provisional Application Ser. No. 61/873,368, filed Sep. 4, 2013

### BACKGROUND OF THE INVENTION

1. Field of the Invention

The invention relates in general to boots for horses and, in particular, to a boot held in place only by bonding the interior surface of the boot to the hoof of the horse.

2. Description of the Prior Art

Horse boots are used to protect the hooves and fetlocks of horses and it has become common place to use them in lieu of horseshoes. A horse boot typically includes a sole with opposed flat, top and bottom, major surfaces that cover the underside of the hoof and an upper that projects upward from the top surface of the sole and forms an enclosure for the hoof of the horse. The upper typically extends along the rim of the sole and has a bottom edge secured to the sole. A tongue is often formed in the front portion of the upper. The top edge of the upper is remote from the sole and is sometime connected to a cuff that can be tightened around the pastern of the horse.

In the typical arrangement, the upper and the cuff (if present) are spread open in order to place the boot on the hoof of the horse. After spreading open the upper and the cuff, the boot is slid over the hoof and the upper is tightened by some means around the hoof to secure the boot in place. Several means for tightening the upper have been used in the art, such as laces, flexible straps, elastic straps, and cables connected to a buckle or other tensioning device mounted on the boot. As the device is closed, it pulls on the cable and tightens both front ends of the upper around the hoof.

Such tensioning devices have been improved and perfected to provide variable degrees of tensioning and ranges of adjustment to fit different riding conditions and hoof sizes. However, fitting a boot to a particular hoof remains a challenge because of the variation in the size and shape of horses' hooves. Even among horses wearing the same size boot (which is determined by the size of the footprint of the hoof), the shape and slope of the hoof's top portion vary from horse to horse, requiring different degrees of tension in order to cause the upper to adhere to the hoof's sides and firmly secure the boot on the hoof. Furthermore, tensioning devices are subjected to severe mechanical stresses during use, especially during hard riding conditions, and therefore they tend to break. When that happens, the only recourse is a replacement boot, which may or may not be available while riding out in the field.

In order to avoid the complications associated with the tensioning devices of prior-art horse boots, in U.S. Pat. No. 4,189,004 Glass describes a simplified configuration of boot that can be affixed simply by screws penetrating the hoof on each side of the lateral walls of the boot. In the form of a slipper with a continuous upper without a rear cup or a tongue, the boot is easily put on from the front by slipping it on until the front and side surfaces of the hoof butt against the interior of the boot's upper. The screws are then inserted into the sides of the hoof through the upper to secure the boot in place. Foam may be used to seal the edge of the upper around the hoof to keep debris out of the boot.

The screws of the Glass approach provide a simplified and durable mechanism for securing a horse boot in place; however, it still requires a laborious procedure for putting the boot on and taking it off. In addition, the slipper configuration of the boot allows a perfect fit when the upper matches well the shape of the hoof, but it does not allow the upper to deform to conform to the hoof when the two are not substantially the same, which is a common recurrence even for same-size hooves. This drawback is underscored by Glass's use of foam to fill the cavities resulting from the fit.

Co-owned U.S. Ser. No. 12/401,107, now abandoned, describes a horse boot secured to the hoof of the horse only by bonding, without any additional restraining device. The boot is designed for a rapid and durable fit, and for maximum flexibility in conforming to the shape of the hoof. The upper includes substantially independent side walls that can be flexed as needed to conform to the shape of the hoof to which the boot is fitted. Prior to fitting, the inside of the boot is lined with bonding material along the interior surface of the upper. The boot is then fitted to the hoof by sliding it into place until the hoof butts firmly against the front of the upper. Because of the shape and flexibility of the upper, the boot conforms readily to the side surface of the hoof and stays in place while the bonding material is hardening, even without pressing against it. The entire fitting process may be carried out in less than two minutes.

In addition to its ease of installation on the hooves of the horse, this boot has shown to be very stable and to remain reliably attached to the hoof during prolonged use simply by virtue of the glue applied to the hoof, without any additional restraining mechanism. However, in part because of the longevity of the attachment, it has been found that moisture and debris that eventually accumulates in the enclosed space between the sole of the boot and the frog of the hoof tend to produce undesirable sanitary conditions. The prolonged lack of aeration facilitates the formation of mold (and a disease condition of the frog called thrush) and any loose particles that find their way into that space produce irritation that cannot be relieved without removal of the boot. Therefore, the logical improvement would be a boot with an open bottom that permits aeration and cleaning of the hoof's underside; that is, in essence, a boot with a horseshoe instead of a sole.

U.S. Pat. No. 4,892,150 (Thoman) describes such a glued-on boot. A polymeric horseshoe is attached to a shoe structure with upward extending tabs that are bonded to the hoof. However, extended tests on a similar boot (i.e., a glued-on boot with an open bottom and a polymeric horseshoe integral with an upper that conforms to the hoof) demonstrated that the boot quickly begins to show signs of loosening from the rear portion of the hoof and eventually it becomes totally separated. It appears that the deformation of the hoof caused by the enlargement of the frog and the quarters of the hoof at each step produces a strain on its bond with the boot. As the hoof increases in size (in width) on impact with the ground, the horseshoe portion of the boot, having an open back side at the heel, is forced to increase its width against its normal shape and the resulting strain eventually produces a breakdown in the bond and the detachment of the boot. Numerous attempts to correct this problem with different placements of the glue and with different retaining structures in the heel were not successful.

U.S. Provisional No. 61/598,884, now expired, described a boot with an open bottom, i.e., without a sole, that solved the problem. The boot includes a structure in the shape of a horseshoe with a conventional open heel that provides support for the hoof bearing on the ground. An upper, preferably integrally formed with the horseshoe, has side walls attached to the outer edge of the horseshoe and can be flexed as needed to conform to the shape of the hoof to which the boot is fitted. In the preferred embodiment of the invention no tongue is present and the upper includes only two portions separated by a frontal slit, each portion consisting of a backward sloping wall normally bent inward to provide pressure against its respective side of the hoof. The novelty consists of a tying strap connecting the two side walls of the upper above the open heel portion of the horseshoe. Critically, the strap must be placed sufficiently high above the open ends of the horseshoe to ensure that it clears the ground on impact during use.

However, it was found that the lack of support for the frog associated with the open sole of such boot affects the circulatory system of the horse, which is in large part based on the pumping action of the frog when the hoof repeatedly presses on the ground. This problem is particularly evident when the boot is worn by race horses, where optimal heart and frog function are essential. In addition, in the case of race horses it was found that the boot is not suitable for changing the breakover point of the hoof, a desirable feature that can affect horse performance.

The breakover time is defined in the art as the moment when the heel of the front hoof lifts off the ground during the stride. The breakover point is the line across the toe of the hoof over which the hoof tilts as it breaks over. The position of the breakover point is crucial to the length of the stride and the way the front hoof lands on the ground, all of which affect racing performance. Therefore, the ability to shift the breakover point is important in horse racing. Traditionally, this has been done by changing the placement of the horseshoe and/or by trimming the toe to shape it so as to shift the breakover point. The present invention addresses both of these is issues in a glued-on boot configuration.

### SUMMARY OF THE INVENTION

The invention is a boot with an open bottom, i.e., without a sole, but including a frog support cantilevered from the back of the boot. A structure in the shape of a horseshoe with a conventional open heel provides the support for the hoof bearing on the ground, but the two open ends at the heel are connected by means of the frog support, which is shaped like an inverted V projecting inward toward the interior of the horseshoe. As a result of the connection, the frog support also provides a spring-like tensioning mechanism urging inward the ends of the horseshoe after they are expanded to fit the hoof. The boot includes an upper, preferably integrally formed with the horseshoe, that has side walls attached to the outer edge of the horseshoe and can be flexed as needed to conform to the shape of the hoof to which the boot is fitted. No tongue or upper is present in the front portion of the shoe and the upper includes only the two side walls, each wall consisting of a backward sloping structure normally bent inward to provide pressure against its respective side of the hoof. According to the invention, the upper and the inner surface of the horseshoe include perforations and connected recesses, respectively, for promoting the distribution of the glue applied during fitting and for increasing the contact surface with the layer of glue bonded to the hoof of the horse.

Inasmuch as the boot of the invention is designed for bonding to the hoof of the horse, prior to fitting the interior surfaces of the upper and of the horseshoe are lined with bonding material, preferably after roughing up the surfaces for better adhesion. The boot then is fitted to the hoof of the horse from the front by opening the upper walls and the free ends of the horseshoe and placing the boot in place. If desired, because the front of the boot is open, the hoof may be positioned slightly forward with respect to the normal placement in order to overhang and shift backward the breakover point of the hoof. Regardless of the exact placement of the boot, because of the shape of the upper and the spring-like action of the frog support, the boot conforms readily to the side surfaces of the hoof and stays in place while the bonding material is hardening even without pressing against it. The entire fitting process can be carried out very rapidly, in a few minutes.

Because the upper's side walls include perforations and the top surface of the horseshoe includes connected notches and recesses that become saturated with a layer of well distributed glue during the process of attaching the boot to the hoof, the amount of glue interposed between the boot and the hoof is materially increased. So is the extent of surface contact between the boot material and the glue, thereby improving the strength of the bond between boot and hoof. An interior pad may be added on the top surface of the horseshoe to prevent excess glue to harden between it and the frog of the hoof.

Various other advantages will become clear from the description of the invention in the specification that follows and from the novel features particularly pointed out in the appended claims. Therefore, this invention includes the features hereinafter illustrated in the drawings, fully described in the detailed description of the preferred embodiments and particularly pointed out in the claims, but such drawings and description disclose only some of the various ways in which the invention may be practiced.

### BRIEF DESCRIPTION OF THE DRAWINGS

FIG. 1 is a perspective view of the left side of a horse boot according to the preferred embodiment of the invention.

FIG. 2 is a perspective view of the front of the horse boot of FIG. 1.

FIG. 3 is a perspective view of the back of the horse boot of FIG. 1.

FIG. 4 is a bottom view of the boot of FIG. 1.

FIG. 5 is a side view of the boot of FIG. 1 fitted to a hoof model.

FIG. 6 is a front view of the boot of FIG. 5.

FIG. 7 is a picture of the boot of FIG. 1 mounted on a horse.

FIG. 8 is a view of the bottom of the boot of FIG. 7.

FIG. 9 is a view of the boot of the invention including a pad installed on the top surface of the horseshoe.

### DETAILED DESCRIPTION OF THE PREFERRED EMBODIMENT

As used herein, the term “sole” is defined to refer only to that part of a horse boot that covers entirely the underside of the hoof of a horse. By contrast, the term “horseshoe” is defined to refer to a structure, made of any material, substantially in the form of a conventional horseshoe with an open heel and an interior open area corresponding substantially to the interior underside of the hoof of a horse. As described with reference to the present invention, the heel portions of the horseshoe are connected by a bridging structure. The term “resilient” is used herein to mean capable of deforming when subjected to a bending, compressing or stretching force and of returning to the original condition when such force is released. In view of the fact that most materials exhibit some degree of resilience, for the purposes of this disclosure and of the claimed invention the term resilient is limited to materials that can be so compressed or stretched by at least 10% of their original dimension or can be bent by at least 30 degrees without suffering any permanent deformation.

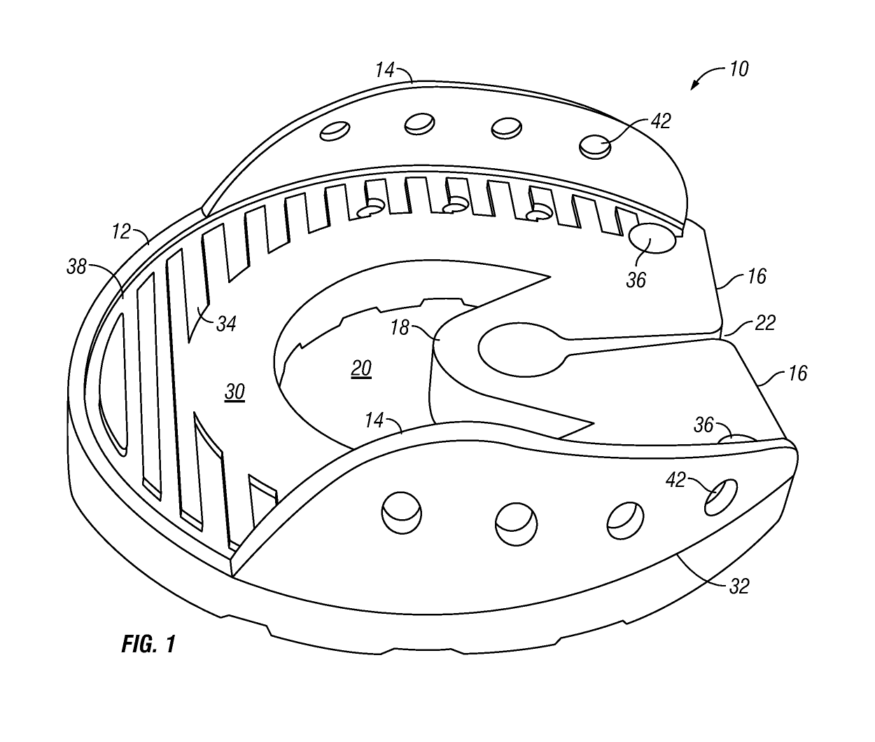

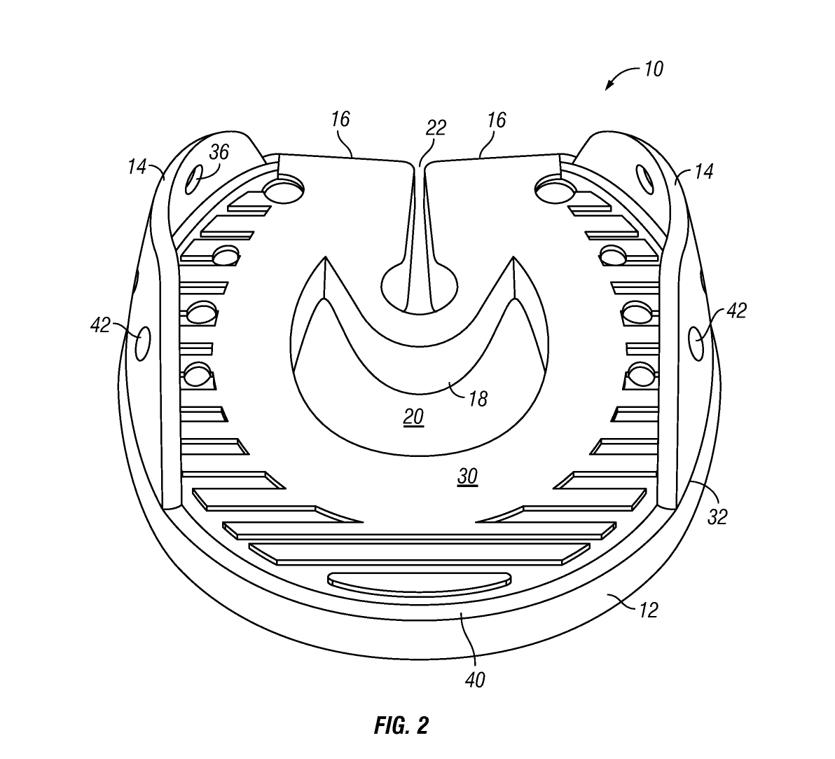

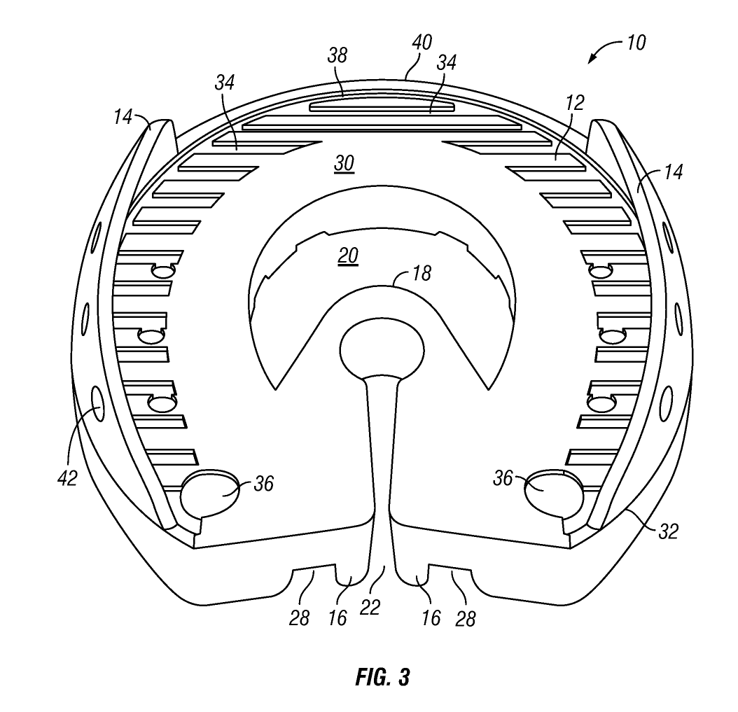

Referring to FIGS. 1, 2 and 3, a glue-on horse boot 10 according to the invention is illustrated. The boot consists of a polymeric bottom part shaped like a conventional horseshoe 12 attached to an upper that includes two side walls 14. The horseshoe 12 has two free ends 16 at the heel of the boot from which a frog support 18 is cantilevered inward toward the open center 20 of the horseshoe. The frog support is roughly shaped like an inverted V attached to the free ends 16 of the horseshoe so as to provide a connection between them through the cantilever portions of the frog support (the legs of the V). As a result of this configuration, the frog support 18 and the open ends 16 of the horseshoe define a gap 22 that can be widened by pulling apart the sides of the horseshoe and the walls 14 of the boot. The resilient (preferably polymeric) material used for the boot 10 allows such deformation. When that is done, the widening of the frog support causes it to act as a spring urging the horseshoe toward its closed position (i.e., toward narrowing the gap 22). As a novel feature of the boot, the frog support 18 thus facilitates the fitting of the boot by making it possible to widen the horseshoe 12 for ease of mounting and then providing inward pressure on the hoof for a stable connection.

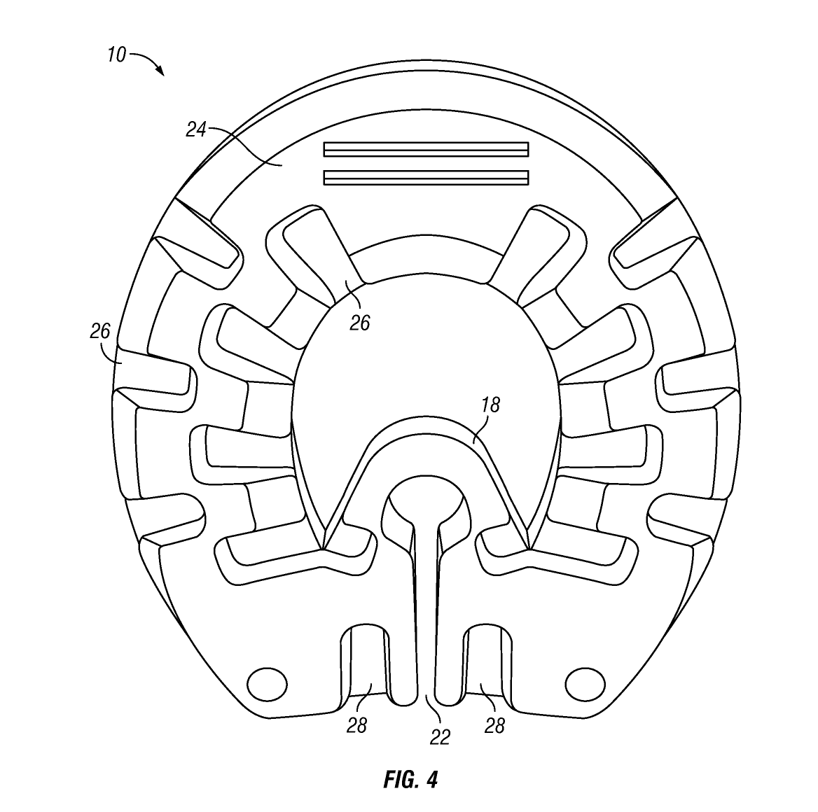

As shown in FIG. 4, the horseshoe 12 includes a bottom surface 24 that is preferably treaded for traction. The treads may take different forms, as best suited for the conditions under which the boot is expected to be used. For example, the surface 24 is equipped with tread protrusions 26 as well as with tread recesses 28. The boot 10 does not have a sole, as conventional horse boots do (and as defined herein), but only a platform in the shape of a horseshoe intended to function as such. That is, the horseshoe 12 is intended and designed so as to bear most of the horse's weight as the boot contacts the ground, thereby providing traction in the same manner as a traditional iron horseshoe would. However, contrary to the effect produced by a stiff iron horseshoe, the ground pressure exerted on the polymeric horseshoe is not only transmitted to the hoof but also allows its lateral deformation. Because of the flexibility of the polymeric material used in the manufacture of the boot, the open bottom 20 of the boot and the open rear portion (the gap 22) of the horseshoe allow the boot's cyclical deformation in function of ground pressure with the attendant benefits to the hoof and frog, which are able to follow their natural cyclical expansion and contraction as the horse repeatedly steps on the ground. In addition, the presence of the frog support 18 guarantees that the frog is compressed when the hoof meets the ground even though the hoof is elevated with respect to ground level (due to the thickness of the horseshoe).

Referring back to FIGS. 1-3, the top surface 30 of the horseshoe 12 is connected to the upper's side walls 14 at its outer edge 32, preferably integrally by means of a unitary construction, leaving a sufficiently large portion of the surface 30 open for gluing to the bottom of the hoof of the horse. As mentioned, interconnected recesses 34 and notches 36 are preferably formed in the surface 30 in order to increase the area of adhesion and thereby enhance the strength of the bond with the bottom of the hoof of the horse. All recesses and notches are interconnected by means of a peripheral channel 38 running substantially along the entire surface of the horseshoe 12. Here again, different shapes of recesses and/or notches may be used as deemed best for a particular application so long as an interconnected grid pattern is established.

The side walls 14 of the upper are very similar to those disclosed in co-owned U.S. Ser. No. 12/340,506, except that the front portion of the walls are removed. The side walls 14 slope downward on each side of hoof, as seen particularly in FIG. 1. The upper is without a tongue and the boot is characterized instead by the open front side, which should be as wide as the front of the hoof of the horse wearing the boot in order to allow the hoof's partial protrusion forward past the rim 40 of the horseshoe. Because of their separation, each lateral wall of the upper can move substantially independent of the other, so that maximum conformance to the shape of the hoof may be obtained when the boot is fitted to the horse. Also, the backward sloping walls are bent inward to provide some built-in inward pressure against the sides of the hoof in addition to the pressure exerted by the frog support due to the expansion of the horseshoe to fit the boot to the hoof. In order to ensure this functional feature of the invention, the boot is designed and molded with a narrower gap 22 than required to fit it to the average hoof for which it is intended. Thus, the free ends 16 of the heel have to be expanded during fitting, which in turn expands the gap 22 connected to the resilient V-shaped frog support 18 and causes it to remain in a loaded condition urging the ends 16 of the horseshoe inward at all times while mounted to the hoof. All boot constituents are sufficiently resilient to permit bending under hand pressure and to conform to the shape of the hoof.

According to another aspect of the invention, the side walls 14 of the upper include lateral perforations 42 distributed along the surfaces of the walls. These perforations are provided to allow excess glue to ooze out during the fitting process and bind to the perforations as well as to portions of the exterior wall surface of the upper. As a result, the portions of the glue cured into the perforations act as studs attached to the upper of the boot, further greatly increasing the shear force required to separate the glue from the boot.

These features have been found to be critical because they prevent the detachment of the boot on impact, a problem experienced with glued-on horseshoes that are either unconnected or rigidly connected at the back end. In particular, the resilient connection provided by the frog support allows the above-described cyclical expansion/contraction of the boot while also forcing all parts of the boot to correspondingly flex and move as a single unit, thereby avoiding the stresses that cause prior-art glued-on boots to detach after brief periods of use. The V-shaped frog support 18 needs to be sufficiently resilient to allow the expansion of the horseshoe to always conform to the shape of the hoof as the hoof expands and to maintain such conformance when the hoof contracts, so that stresses between the hoof and the horseshoe are avoided. To that end, the use of an elastic polymeric material such as urethane is ideal. In contrast, more rigid materials such as metal and rigid plastics were found not to allow the conforming behavior necessary for a lasting bond between the horseshoe and the bottom of the hoof.

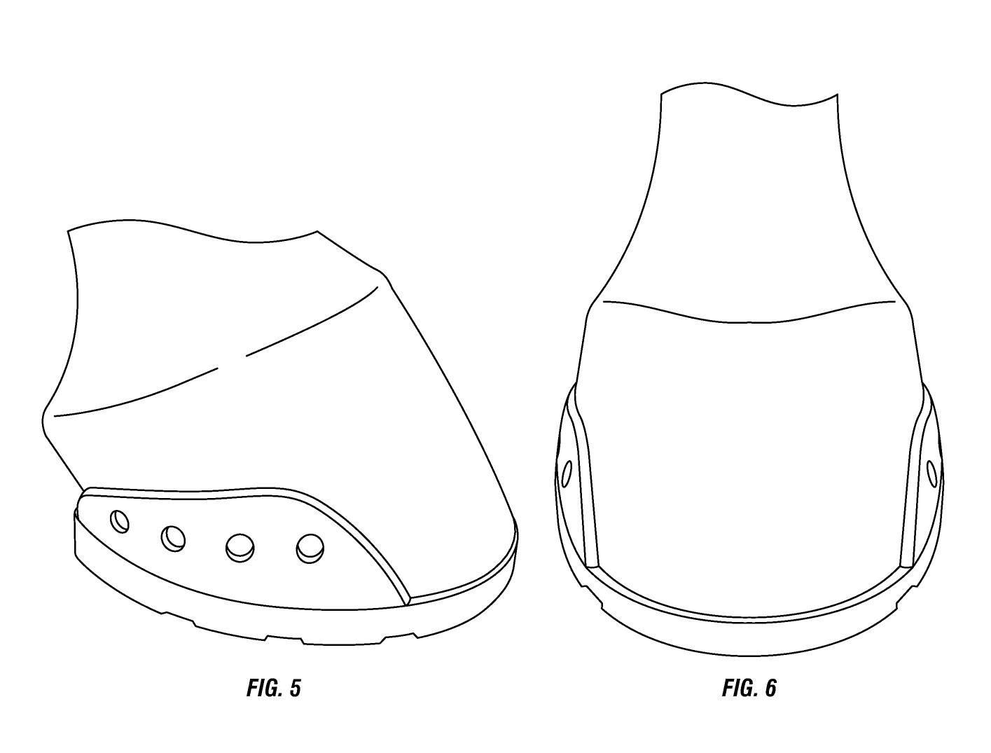

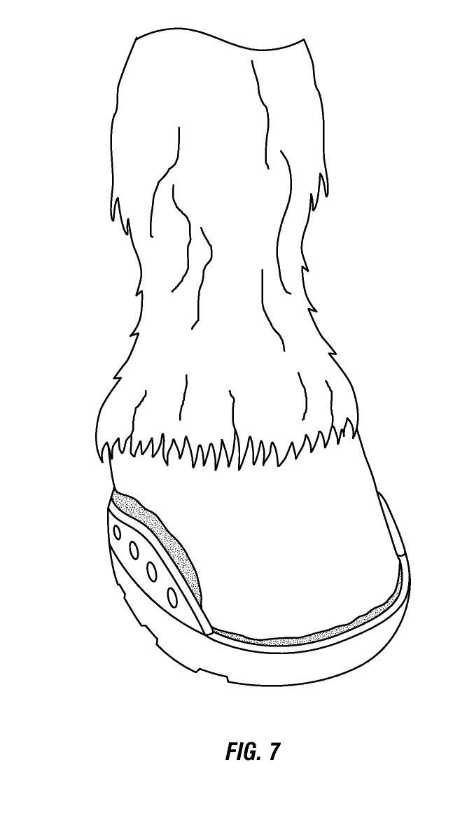

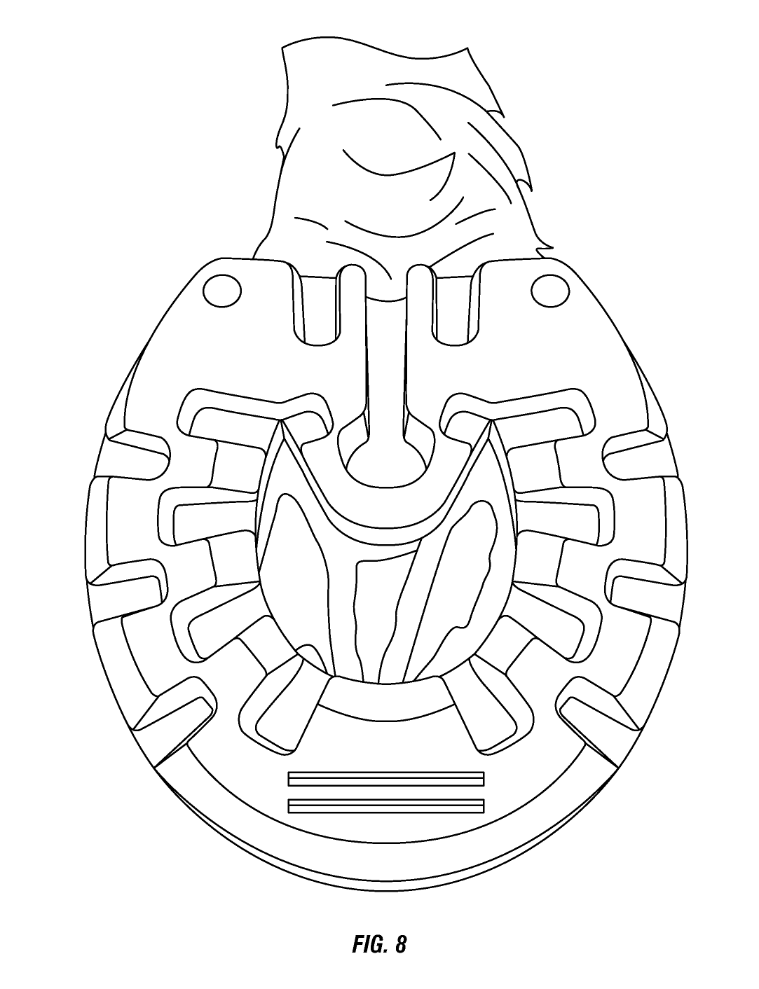

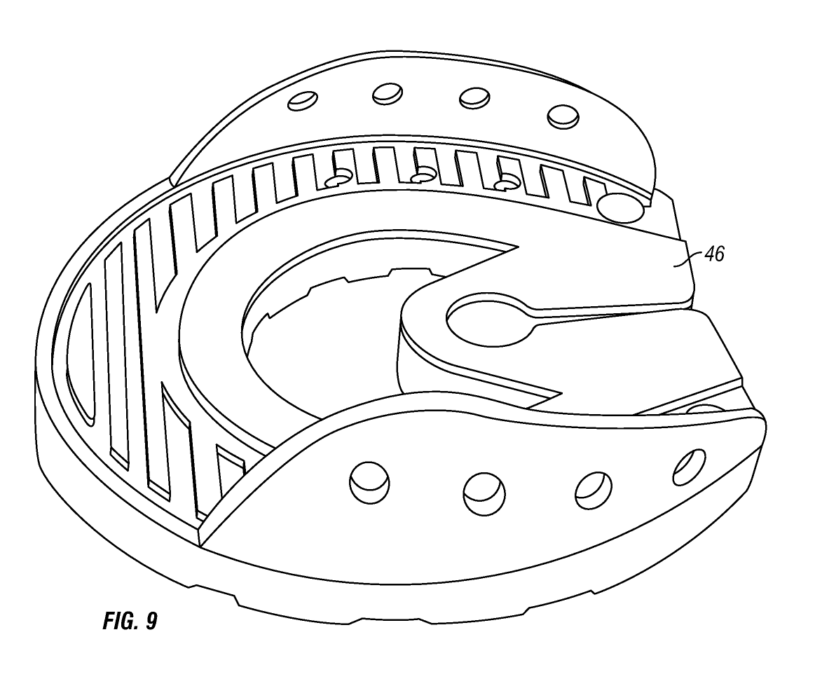

In use, the boot 10 is installed using only glue to secure it to the hoof. After placing an appropriate amount of bonding material on the interior surface of the side walls 14 of the upper and throughout the top surface 30 of the horseshoe 12, the boot is slipped under the hoof from the front while keeping the side walls open until the front of the hoof has reached the desired position. (Note that, due to the absence of a tongue or a front wall, the hoof can be moved forward so as to extend past the front rim 40 of the horseshoe, thereby shifting backward the natural breakover point of the hoof.) It was found that an amount of glue appropriate to form a layer between 1.5 and 3 mm in thickness (excluding the thickness of the recesses and notches) is ideal. Though typically not necessary, additional bonding material may be applied between the hoof and the horseshoe and/or the edges of the upper in sufficient quantity to assure complete coverage of the abutting surfaces and penetration of the glue into the recesses 34 and the perforations 42. The boot is then kept firmly in place for the time required for the bonding material to set. Currently available polyurethane glues, such as the product marketed under the mark Adhere by the Vettec Company of Oxnard, California, cure in less than 90 seconds. Therefore, the boot need not be held in place long before it is firmly attached to the hoof. The entire fitting process may be accomplished comfortably in less than five minutes. FIGS. 5 and 6 illustrate the conforming features of the boot of the invention with a plastic hoof model. FIGS. 7 and 8 show the boot glued onto the hoof of a horse. FIG. 8, in particular, shows the expanded condition of the gap 22 in the horseshoe after the boot is fitted to the hoof, which clearly illustrates the retention function provided by the resilient frog support.

The side walls 14 should be formed with an average angle that is adequate for pressing naturally inward against the walls of the hoof when installed. Such angle is measured between the plane of the top surface 30 of the horseshoe 12 and a straight line connecting the interior bottom edge (secured to the horseshoe) to the top edge of the side wall approximately halfway along the length of the boot. Preferably, an angle of no more than approximately 65 degrees with respect to the plane of the horseshoe 12 is appropriate in order to at least match the slope of the sides of the average hoof so as to press against it to help keep the boot in place even prior to gluing. The ideal shape of the upper of the boot of the invention is essentially the same as that of the slipper boot described by the Glass patent referenced above, but with the additional critical features of the perforations 42, the inward-folded side walls, and—most importantly—the resilient frog support 18 connecting the free ends 16 of the horseshoe in the cantilevered fashion described herein. These features make it possible to fit the upper to the actual shape of the hoof and to provide deformation of the boot conforming to the changes in shape of the hoof during use, thereby making it possible to improve adherence and reliably attach the boot solely with bonding material.

It has been found that excessive usage of glue may cause an accumulation of hardened material along the inner perimeter of the top surface 30 of the horseshoe 12. This results from the fact that at rest the frog defines a concavity in the underside of the hoof where excess glue material can accumulate during the process of installing the shoe, which is done with the hoof bent up in the air with no pressure applied to it. If such accumulation of glue occurs and hardens, it creates a layer of material that interferes with the natural movement of the frog when pressure is applied through the hoof. The same problem can occur during use even without glue accumulation if the horse walks on mud or loose debris that can penetrate the open bottom of the horseshoe and find its way into the space between the surface of the horseshoe and the frog. Note that the average width of the annular surface 30 of the horseshoe is greater than the width of the typical metal horseshoe (about 1.5 inches versus about ¾ of an inch); therefore, the horseshoe 12 overlaps to some extent with the frog, thereby forming the open space that can retain debris and create the problems mentioned here.

In view of the foregoing, the boot of invention may also be fitted with a resilient foam pad 46, as illustrated in FIG. 9, that prevents the accumulation of glue during the process of installing the shoe as well as the accumulation of debris afterward. The preferred pad is a ring along the inner region of the surface 30 of the horseshoe 12 made of a polyurethane foam layer about ⅛ of an inch thick. While the accumulation of glue may be controlled during application even without the pad 46, the use of pad is preferred whenever a potential problem of debris accumulation exists.

Using the glue marketed under the mark Adhere by the Vettec Company of Oxnard, California, the boot of the invention has been fitted to many horses and tested for periods of several weeks without failure, with no sign of separation of the glue from the hoof, as experienced with previous glued-on boot configurations. This result was obtained in spite of the normal aging and cell replacement of the hoof, which is believed to have caused the outer layers of the hoof to separate from the bonding material in previous glued-on boots. This apparently maintenance-free use of the boot of the invention renders it ideal for recreational riding as well as endurance events and races during which it is particularly important to be able to ride without boot failures.

Thus, a polymeric horse boot has been disclosed that can be glued reliably on the hoof of a horse. The combination of the structural configuration and the resilient material used to fabricate the boot allows the cyclical expansion and contraction of the hoof necessary for its natural blood-pumping function. The boot is preferably molded as an item of unitary construction out of polyurethane material with hardness 90 on the Shore A durometry scale for testing materials' hardness according to ASTM D2240-00 standards. As the hoof grows and its footprint naturally expands with time, the horseshoe portion of the boot can expand with the hoof, avoiding the contracted-heel problem often associated with iron shod horses. In addition, the heel portions of the horseshoe are also free to move independently in the vertical plane, which allows the bottom of the boot to conform to the natural deformation of the hoof when it steps on uneven ground. Finally, the combination of the shape of the horse boot and the spring effect produced by the horseshoe bridge produces a boot that inherently presses against and conforms to the hoof, which greatly enhances the boot's stability during installation and use.

While the invention has been shown and described herein with reference to what are believed to be the most practical embodiments, it is recognized that departures can be made within the scope of the invention. Therefore, the invention is not to be limited to the details disclosed herein but is to be accorded the full scope of equivalent articles.

1. A glued-on horse boot comprising:
a horseshoe with heel portions defining gap, a top surface of the horseshoe containing a grid of recesses for receiving an adhesive material;
an upper with two side walls attached to an outer periphery of the horseshoe and folded inward to butt against a hoof of a horse wearing the boot;
a frog support connecting the heel portions of the horseshoe; and
bonding material placed between the hoof of the horse and said top surface of the horseshoe and between the hoof and interior surfaces of the side walls for adhering the boot to the hoof;
wherein the frog support is a resilient structure cantilevered inward from said heel portions of the horseshoe so as to urge closure of said gap when the boot is fitted to the hoof.

2. The horse boot of claim 1, wherein said side walls contain lateral perforations.

3. The horse boot of claim 1, wherein said recesses are interconnected via a peripheral channel in the horseshoe.

4. The horse boot of claim 1, wherein said upper, horseshoe and frog support are made of integral unitary construction.

5. The horse boot of claim 1, wherein said upper, horseshoe and frog support are made of polyurethane material.

6. The horse boot of claim 1, wherein said horseshoe includes a bottom surface with treads.

7. The horse boot of claim 1, wherein each of said side walls is normally folded inward at an angle not greater than 65 degrees with respect to the horseshoe's surface, said angle being measured between the top surface of the horseshoe and a straight line connecting an interior bottom edge to a top edge of the side wall approximately halfway along a length of the boot.

8. The horse boot of claim 1, further comprising a pad over an inner region of said top surface of the horseshoe.

9. A glued-on horse boot comprising:
a horseshoe with heel portions defining gap, a top surface of the horseshoe containing a grid of recesses interconnected via a peripheral channel for receiving an adhesive material, and a bottom surface with treads;
an upper with two side walls attached to an outer periphery of the horseshoe and folded inward to butt against a hoof of a horse wearing the boot, said side walls containing lateral perforations for receiving said adhesive material;
a pad over an inner region of said top surface of the horseshoe;
a frog support connecting the heel portions of the horseshoe; and
bonding material placed between the hoof of the horse and said top surface of the horseshoe and between the hoof and interior surfaces of the side walls for adhering the boot to the hoof;
wherein the frog support is a resilient structure cantilevered inward from said heel portions of the horseshoe so as to urge closure of said gap when the boot is fitted to the hoof;
wherein said upper, horseshoe and frog support are made of polyurethane material of integral unitary construction; and
wherein each of said side walls is normally folded inward at an angle not greater than 65 degrees with respect to the horseshoe's surface, said angle being measured between the top surface of the horseshoe and a straight line connecting an interior bottom edge to a top edge of the side wall approximately halfway along a length of the boot.

10. A method of fitting a horse boot to a hoof of a horse, comprising the following steps:
providing a boot that includes:
a horseshoe with heel portions defining gap, a top surface of the horseshoe containing a grid of recesses;
an upper with two side walls attached to an outer periphery of the horseshoe and folded inward to butt against the hoof of the horse wearing the boot; and
a frog support connecting the heel portions of the horseshoe;
wherein the frog support is a resilient structure cantilevered inward from said heel portions of the horseshoe so as to urge closure of said gap when the boot is fitted to the hoof; and
applying bonding material on said top surface of the horseshoe and on interior surfaces of the side walls;
fitting the boot to the hoof of the horse; and
holding the boot in place until the bonding material has cured.

11. The method of claim 10, wherein the boot further comprises a pad over an inner region of said top surface of the horseshoe, and wherein said bonding material is applied to the top surface of the horseshoe outside the pad.

12. The horse boot of claim 10, wherein said side walls contain lateral perforations.

13. The method of claim 10, wherein said recesses are interconnected via a peripheral channel in the horseshoe.

14. The method of claim 10, wherein said upper, horseshoe and frog support are made of integral unitary construction.

15. The method of claim 10, wherein said upper, horseshoe and frog support are made of polyurethane material.

16. The method of claim 10, wherein said horseshoe includes a bottom surface with treads.

17. The method of claim 10, wherein each of said side walls is normally folded inward at an angle not greater than 65 degrees with the horseshoe's surface, said angle being measured between a top surface of the horseshoe and a straight line connecting an interior bottom edge to a top edge of the side wall approximately halfway along a length of the boot.
